(19) United States
(12) Patent Application Publication
(10) Pub. No.: US 2007/0268311 A1
(43) Pub. Date: Nov. 22, 2007

(54) OVERLAPPING MEKKO CHARTS

(76) Inventor: Stephen M. Smith, Westlake Village, CA (US)

Correspondence Address: HOFFMAN, WARNICK & D'ALESSANDRO LLC, 75 STATE ST, 14TH FLOOR, ALBANY, NY, 12207, US

(21) Appl. No.: 11/419,623

(22) Filed: May 22, 2006

(51) Int. Cl. G09G 5/00

(52) U.S. Cl. 345/629

(57) ABSTRACT

The invention is directed to the creation of overlapping Mekko charts. A method according to an embodiment of the invention includes: creating a base Mekko chart having a plurality of columns, wherein each column includes a plurality of elements, and wherein each element represents a data value; creating a first overlay for the base Mekko chart, wherein the first overlay includes a plurality of shapes, and wherein each shape is nested within a respective element of the base Mekko chart and represents a portion of the data value of the respective element; creating a second overlay for the base Mekko chart, wherein the second overlay includes a plurality of indicators, and wherein each indicator is positioned within a respective element of the base Mekko chart and does not represent a portion of the data value of the respective element; and displaying the first and second overlays on the base Mekko chart.

### BACKGROUND OF THE INVENTION

1. Field of the Invention

The present invention generally relates to the graphical display of data, and more specifically relates to the creation of overlapping Mekko charts.

2. Related Art

When displaying a large amount of data, there are many graphical representations that can be used including, for example, bar charts, pie charts, area charts, and a type of chart often used by strategy consultants called a Marimekko or “Mekko” Chart. Mekko charts are two-dimensional graphs that analyze multiple data series against two variables, the X and Y axes. The charts are so named for their tapestry-like appearance. The Mekko chart can be used in many different industries. Its function is to display a system of interrelated values so that both groups and relative sizes of the elements can be seen at the same time. In a Mekko chart, the widths of the columns are proportional to data represented by the columns, while individual segment height is a percentage of the respective bar total value.

When visually examining a Mekko chart, a person can quickly tell how large the various horizontal columns are in aggregate and how large the elements are within each of those columns. An illustrative Mekko chart 10 is illustrated in FIG. 1. The Mekko chart 10 includes a plurality of columns 12 including “Marketing, Sales and Services,” “Supply Chain Management,” “Engineering,” and “Human Resources” (note that these are just examples of data sets and they could be any types of categories). Within each of the columns 12 are a number of elements 14. To this extent, by looking across the entire Mekko chart 10 or within the columns 12, a person can easily determine, for instance, how large an opportunity (e.g., sales) is in comparison with other displayed data in the Mekko chart 10. This provides a good single-level of analysis. However, the Mekko chart 10 does not provide for the display of multiple levels of data and sub-data in an overlapping manner, nor the display of non-area types of information (e.g., growth rates, margins, etc.) in an overlapping manner. To provide this type of functionality would require the generation of one or more additional sets of charts and the manual mapping of data.

### SUMMARY OF THE INVENTION

The present invention is directed to the creation of overlapping Mekko charts.

A first aspect of the present invention is directed to a method for providing an overlapping Mekko chart, comprising: creating a base Mekko chart having a plurality of columns, wherein each column includes a plurality of elements, and wherein each element represents a data value; creating a first overlay for the base Mekko chart, wherein the first overlay includes a plurality of shapes, and wherein each shape is nested within a respective element of the base Mekko chart and represents a portion of the data value of the respective element; creating a second overlay for the base Mekko chart, wherein the second overlay includes a plurality of indicators, and wherein each indicator is positioned within a respective element of the base Mekko chart and does not represent a portion of the data value of the respective element; and displaying the first and second overlays on the base Mekko chart.

A second aspect of the present invention is directed to a system for providing an overlapping Mekko chart, comprising: a system for creating a base Mekko chart having a plurality of columns, wherein each column includes a plurality of elements, and wherein each element represents a data value; a system for creating a first overlay for the base Mekko chart, wherein the first overlay includes a plurality of shapes, and wherein each shape is nested within a respective element of the base Mekko chart and represents a portion of the data value of the respective element; a system for creating a second overlay for the base Mekko chart, wherein the second overlay includes a plurality of shapes, and wherein each shape in the second overlay is nested within a respective shape of the first overlay and represents a portion of the data value of the respective shape of the first overlay; and a system for displaying the first and second overlays on the base Mekko chart.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative Mekko chart in accordance with the prior art.

FIGS. 2-4 depict illustrative Mekko charts in accordance with embodiments of the present invention.

FIG. 5 depicts an illustrative computer system for implementing embodiment(s) of the present invention.

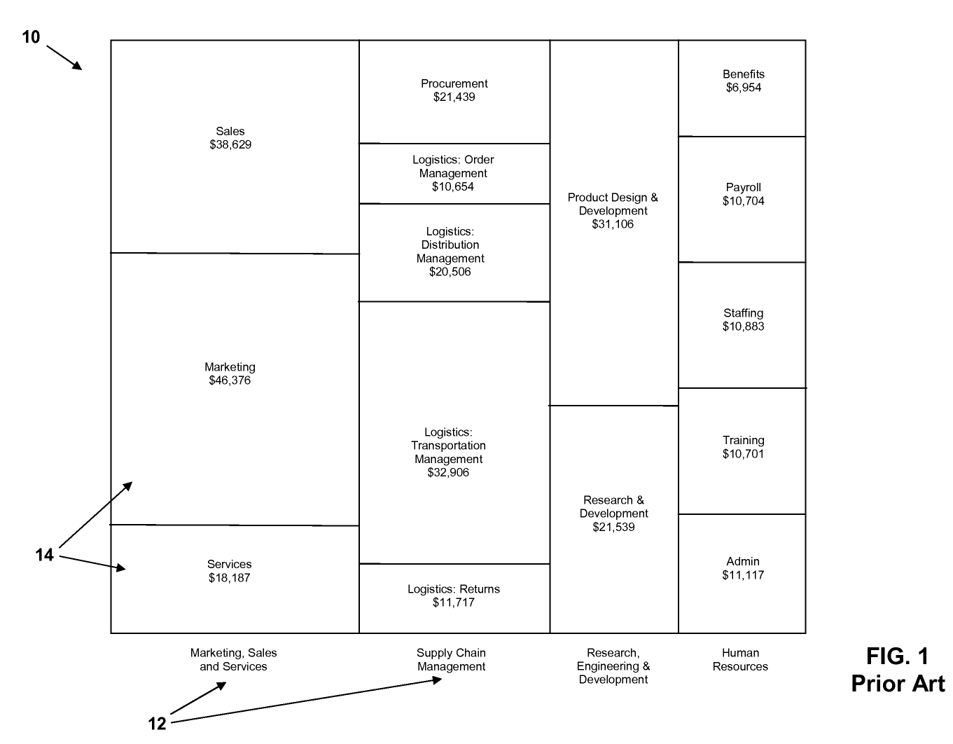

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

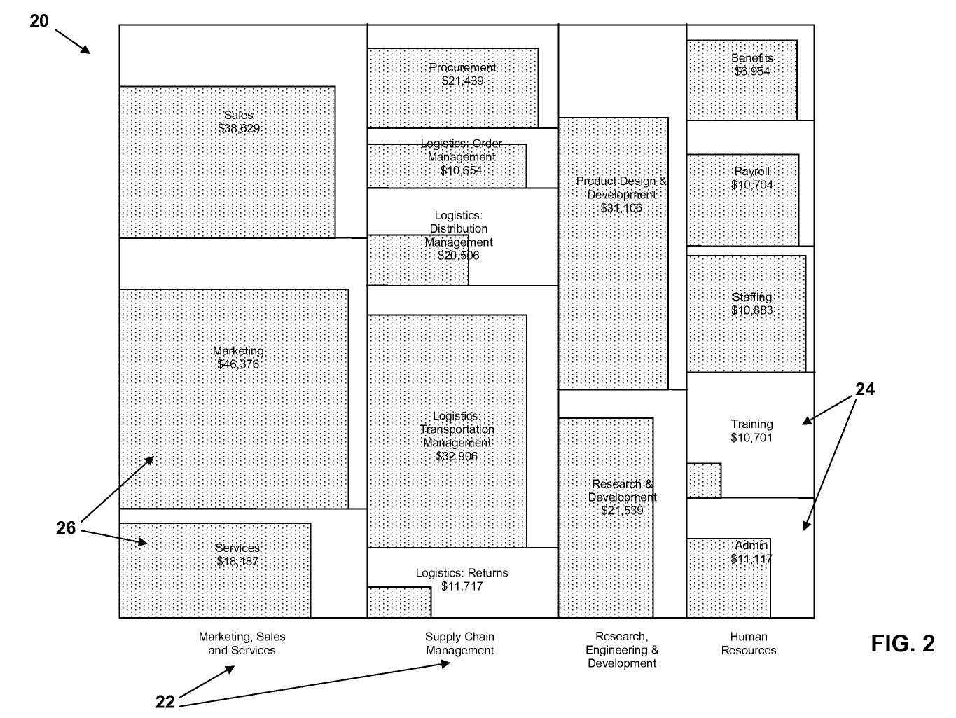

An illustrative Mekko chart 20 in accordance with an embodiment of the present invention is depicted in FIG. 2. The Mekko chart 20 includes a plurality of columns 22 including “Marketing, Sales and Services,” “Supply Chain Management,” “Engineering,” and “Human Resources.” Within each of the columns 22 are a number of elements 24. In this example, a first overlay in the form of nested rectangles 26 and representing a new type of data is created and displayed on the “base” Mekko chart 20. For instance, the data in the first overlay could represent how much spending in each of the elements 24 corresponds to a certain type of spending (e.g., processing services). Each of the nested rectangles 26 can be oriented as shown such that the lower left corner of a nested rectangle 26 is aligned with the lower left corner of a respective element 24. Many other orientations are also possible. Further, shapes other than rectangles could be used. In this example, the size of each nested rectangle 26 represents the size of the opportunity for processing services within a respective element 24.

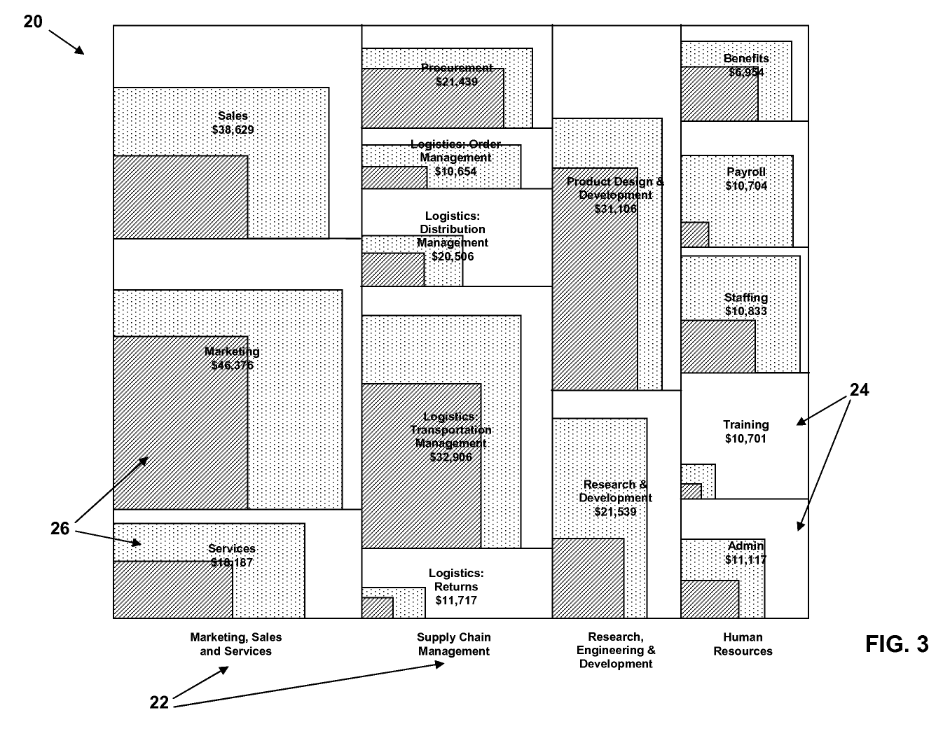

The above-described example can be taken a step further as shown in FIG. 3 by providing a second overlay on the Mekko chart 20 in the form of nested rectangles 28. As such, three different sets of data are now displayed. In this case, the nested rectangles 28 are located within the nested rectangles 26 and represent how much of the spending of the nested rectangles 26 is performed, for example, by large enterprises. Each of the nested rectangles 28 can be oriented as shown such that the lower left corner of a nested rectangle 28 is aligned with the lower left corner of a respective nested rectangle 26. Again, many other orientations are also possible, and shapes other than rectangles could be used. In general, each nested rectangle 28 represents a portion of a respective nested rectangle 26, based on one or more predetermined criteria (e.g., portion of spending, etc.). The size of each nested rectangle 26, 28 represents the size of the opportunity for processing services and large enterprises within a corresponding element 24, respectively. This allows a person to quickly determine where there might be opportunities and to gather insights that are not available in conventional Mekko charts.

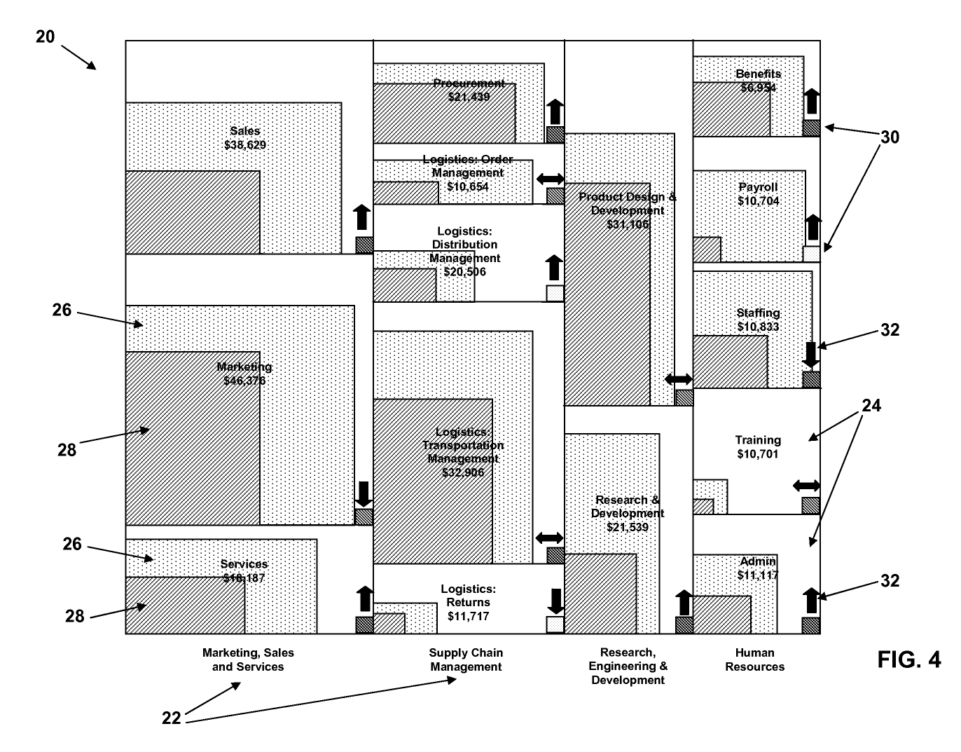

An overlay comprising other types of “non-area” data can also be overlaid or “mapped” on the Mekko chart 20. For example, as shown in FIG. 4, an indicator 30 of the growth rate of an opportunity in each element 24 in the Mekko chart 20 can be displayed. The indicator 30 can be color coded (e.g., green for an opportunity growing at a rate of >10%, yellow for an opportunity growing at a rate of 8-10%, and red for an opportunity growing at a rate of <8%) or can comprise any suitable type of indicator that conveys the intended information.

Another type of indicator 32, representing items such as the capabilities of a company in each of the elements 24, or growth rates in each of the elements 24, can also be overlaid on the Mekko chart 20. For example, a first indicator such as “ [symbol] ” can be used to indicate “high,” a second indicator such as “ [symbol] ” can be used to indicate “mid,” and a third indicator “ [symbol] ” can be used to indicate “low.” The indicators 32 can also be color coded as desired. In general, in accordance with the present invention, any suitable type of indicator representing any desired type of information can overlaid on the Mekko chart 20. By examining the Mekko chart 20 shown in FIG. 4, a person can now easily obtain a comprehensive picture of market opportunity and can easily determine how fast areas (i.e., elements 24) are growing and the strength of a company's capabilities in those areas. This allows analysis such as “where is growth where we have strong capability or no capability,” “are we over-investing in areas where we have strong capability but the market size is small and not growing quickly,” etc.

In accordance with the present invention, an initial primary data set (in this case overall market opportunity) is obtained and a Mekko chart (which is a standard often used by consulting firms) is created using the primary data set. This can be done using a spreadsheet application such as Excel, a graphing application, and the like. Additional data sets can then be overlaid or “mapped” on top of the Mekko chart in a nested fashion (there could be as many nestings as desired). This can be done using a program or programming language such as Visual Basic for Applications (VBA) to position items (e.g., nested rectangles, indicators, etc.) in the correct locations on the Mekko chart, calculate the appropriate size areas, etc. The method allows for a virtually unlimited number of nestings, options and overlays. The program runs by loading all of the data that the user is looking to map and then asks the user to identify the initial primary data set to be used to create the Mekko chart. The program can provide a series of drop-down menus or other selection mechanisms for the selection of additional overlays and extra options to map. In response to a user selection, the program generates the desired overlays and/or indicators.

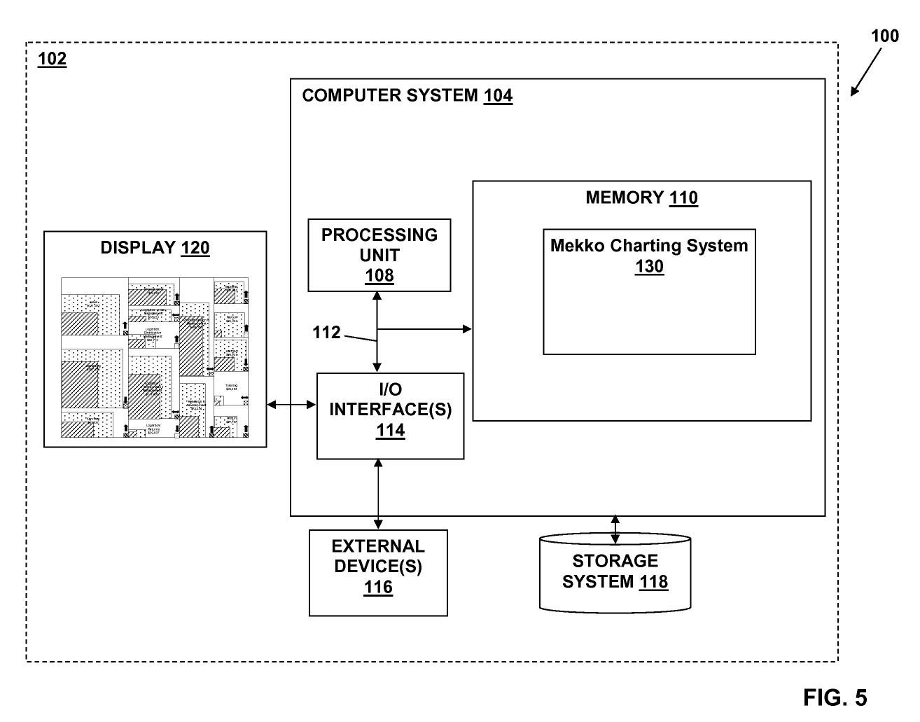

FIG. 5 shows an illustrative system 100 in accordance with embodiment(s) of the present invention. The system 100 includes a computer infrastructure 102 that can perform the various process steps described herein. In particular, the computer infrastructure 102 is shown as including a computer system 104 that comprises a Mekko charting system 130. The Mekko charting system 130 enables the computer system 104 to create overlapping Mekko charts as described above.

The computer system 104 is shown as including a processing unit 108, a memory 110, at least one input/output (I/O) interface 114, and a bus 112. Further, the computer system 104 is shown in communication with at least one external device 116 and a storage system 118. In general, the processing unit 108 executes computer program code, such as the Mekko charting system 130, that is stored in memory 110 and/or storage system 118. While executing computer program code, the processing unit 108 can read and/or write data from/to the memory 110, storage system 118, and/or I/O interface(s) 114. Bus 112 provides a communication link between each of the components in the computer system 104. The at least one external device 116 can comprise any device (e.g., display 120) that enables a user (not shown) to interact with the computer system 104 or any device that enables the computer system 104 to communicate with one or more other computer systems.

The computer system 104 can comprise any general purpose computing article of manufacture capable of executing computer program code installed by a user (e.g., a personal computer, server, handheld device, etc.). However, it is understood that the computer system 104 and the Mekko charting system 130 are only representative of various possible computer systems that may perform the various process steps of the invention. To this extent, in other embodiments, the computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, the computer infrastructure 102 is only illustrative of various types of computer infrastructures that can be used to implement the invention. For example, in one embodiment, the computer infrastructure 102 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

The Mekko charting system 130 enables the computer system 104 to create overlapping Mekko charts as described above. The Mekko charting system 130 includes a program capable of providing a Mekko chart and a program for generating overlays and indicators on the Mekko chart. Operation of each of these systems is discussed above.

It is understood that some of the various systems shown in FIG. 5 can be implemented independently, combined, and/or stored in memory for one or more separate computer systems 104 that communicate over a network. Further, it is understood that some of the systems and/or functionality may not be implemented, or additional systems and/or functionality may be included as part of the system 100.

While shown and described herein as a method and system for creating overlapping Mekko charts, it is understood that the invention further provides various alternative embodiments. For example, in one embodiment, the invention provides a computer-readable medium that includes computer program code to enable a computer infrastructure to create overlapping Mekko charts. To this extent, the computer-readable medium includes program code, such as the Mekko charting system 130, which implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as the memory 110 and/or storage system 118 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to create overlapping Mekko charts as described above. In this case, the service provider can create, maintain, support, etc., a computer infrastructure, such as the computer infrastructure 102, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method for creating overlapping Mekko charts. In this case, a computer infrastructure, such as the computer infrastructure 102, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as the computer system 104, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of the preferred embodiments of this invention has been presented for purposes of illustration and description. It is not intended to be exhaustive or to limit the invention to the precise form disclosed, and obviously, many modifications and variations are possible.

1. A method for providing an overlapping Mekko chart, comprising:
creating a base Mekko chart having a plurality of columns, wherein each column includes a plurality of elements, and wherein each element represents a data value;
creating a first overlay for the base Mekko chart, wherein the first overlay includes a plurality of shapes, and wherein each shape is nested within a respective element of the base Mekko chart and represents a portion of the data value of the respective element;
creating a second overlay for the base Mekko chart, wherein the second overlay includes a plurality of indicators, and wherein each indicator is positioned within a respective element of the base Mekko chart and does not represent a portion of the data value of the respective element; and
displaying the first and second overlays on the base Mekko chart.

2. The method of claim 1, wherein the plurality of shapes comprise rectangles.

3. The method of claim 2, further comprising:
aligning a corner of each rectangle with a corner of the respective element of the base Mekko chart.

4. The method of claim 1, further comprising:
creating a third overlay for the base Mekko chart, wherein the third overlay includes a plurality of shapes, and wherein each shape in the third overlay is nested within a respective shape of the first overlay and represents a portion of the data value of the respective shape of the first overlay.

5. A system for providing an overlapping Mekko chart, comprising:
a system for creating a base Mekko chart having a plurality of columns, wherein each column includes a plurality of elements, and wherein each element represents a data value;
a system for creating a first overlay for the base Mekko chart, wherein the first overlay includes a plurality of shapes, and wherein each shape is nested within a respective element of the base Mekko chart and represents a portion of the data value of the respective element;
a system for creating a second overlay for the base Mekko chart, wherein the second overlay includes a plurality of shapes, and wherein each shape in the second overlay is nested within a respective shape of the first overlay and represents a portion of the data value of the respective shape of the first overlay; and
a system for displaying the first and second overlays on the base Mekko chart.

6. The system of claim 5, wherein the plurality of shapes comprise rectangles.

7. The system of claim 6, further comprising:
a system for aligning a corner of each rectangle with a corner of the respective element of the base Mekko chart.

8. The system of claim 5, further comprising:
creating a third overlay for the base Mekko chart, wherein the third overlay includes a plurality of indicators, and wherein each indicator is positioned within a respective element of the base Mekko chart and does not represent a portion of the data value of the respective element.
